(19) United States
(12) Patent Application Publication
(10) Pub. No.: US 2011/0188964 A1
(43) Pub. Date: Aug. 4, 2011

(54) Magnesium Screw Manufacturing Method and Magnesium Screw Member Produced Thereof

(76) Inventor: Kuo-Chen Hung, Kaohsiung County (TW)

(21) Appl. No.: 12/945,066

(22) Filed: Nov. 12, 2010

Related U.S. Application Data
(63) Continuation-in-part of application No. 12/783,703, filed on May 20, 2010.

(30) Foreign Application Priority Data
Feb. 3, 2010 (TW) 099103099

(51) Int. Cl. F16B 35/00; B21H 3/02

(52) U.S. Cl. 411/393; 470/9

(57) ABSTRACT

A magnesium screw manufacturing method includes the steps of: providing a magnesium wire or rod; processing a directly-heating procedure, a thermal insulation material coating and directly-heating procedure or a directly-heating and thermal insulation material coating procedure on the magnesium wire or rod; forming a screw head and a screw thread of a screw blank from the magnesium wire or rod to produce a magnesium screw member.

### CROSS REFERENCE TO RELATED APPLICATIONS

This application is a continuation-in-part of U.S. patent application Ser. No. 12/783,703, filed May 20, 2010, which is hereby incorporated by reference in its entirety.

### BACKGROUND OF THE INVENTION

1. Field of the Invention

The present invention relates to a magnesium screw manufacturing method and a magnesium screw member produced thereby. More particularly, the present invention relates to a magnesium screw manufacturing method for a magnesium wire or rod in a directly-heating treatment to produce a magnesium screw member.

2. Description of the Related Art

U.S. Pat. Appl. Pub. No. 20060130947, entitled “Magnesium-based alloy screw and method of manufacturing the same,” discloses a magnesium-based alloy screw manufacturing method, including the steps of: head-forging step and thread-rolling step. In the head-forging step a holding die is used to mount a magnesium alloy wire and a screw head is formed on the magnesium alloy wire by a punch member.

In the thread-rolling step both of the holding die and the punch member are heated in a predetermined temperature, ranging between 140 and 250 degrees Celsius. Accordingly, both of the heated holding die and the heated punch member further heat the magnesium alloy wire to the predetermined temperature such that the magnesium alloy wire is processed in indirectly-heating treatment.

However, the above-mentioned method requires preheating the holding die and the punch member in a predetermined temperature prior to processing the forging the screw head. After heated, the holding die and the punch member can be used to forge the magnesium alloy wire that results in sophistications in process. In addition, the holding die and the punch member must be repeatedly heated in maintaining the temperature (i.e. operation temperature) that may also result in energy waste and an increase of manufacturing cost.

Briefly, the manufacturing method described in No. 20060130947 is unsuitable for mass production. Hence, there is a need of providing a screw manufacturing method to improve the above problems of the complicated process, waste energy and increasing manufacture cost. In other words, there is a need of providing an improved screw manufacturing method suitable for mass production.

As is described in greater detail below, the present invention provides a magnesium screw manufacturing method and a magnesium screw member produced thereby. A magnesium wire or rod is processed in a directly-heating process, a thermal insulation material coating and directly-heating procedure or a directly-heating and thermal insulation material coating procedure to produce the magnesium screw member in such a way as to mitigate and overcome the above problem.

### SUMMARY OF THE INVENTION

The primary objective of this invention is to provide a magnesium screw manufacturing method and a magnesium screw member produced thereby. A magnesium wire or rod is processed in a directly-heating procedure, a thermal insulation material coating and directly-heating procedure or a directly-heating and thermal insulation material coating procedure to produce the magnesium screw member. Accordingly, the magnesium screw manufacturing method is successful in simplifying the entire process.

The magnesium screw manufacturing method in accordance with an aspect of the present invention includes the steps of:

providing a magnesium wire or rod with a predetermined diameter;

directly heating the magnesium wire or rod in a predetermined temperature; and

forming a screw head and a screw thread of a screw blank from the magnesium wire or rod.

As is described above, a magnesium screw member comprises a screw head and a screw rod connected therewith formed from a magnesium wire or rod with a predetermined diameter in a directly heating procedure, wherein the screw rod has a thread portion.

The magnesium screw manufacturing method in accordance with a separate aspect of the present invention includes the steps of:

providing a magnesium wire or rod with a predetermined diameter;

thermal insulation material coating and directly heating the magnesium wire or rod, or directly heating and thermal insulation material coating the magnesium wire or rod; and

forming a screw head and a screw thread of a screw blank from the magnesium wire or rod.

As is described above, a magnesium screw member comprises a screw head and a screw rod connected therewith formed from a magnesium wire or rod with a predetermined diameter in a thermal insulation material coating and directly-heating procedure or a directly-heating and thermal insulation material coating procedure, wherein the screw rod has a thread portion.

In yet a further separate aspect of the present invention, the magnesium wire or rod is made from a magnesium alloy material.

In yet a further separate aspect of the present invention, the predetermined temperature ranges between 100° C. and 300° C.

In yet a further separate aspect of the present invention, the thermal insulation material is selected from an inorganic material or an organic material.

In yet a further separate aspect of the present invention, the inorganic material is selected from graphite or boron nitride (BN).

In yet a further separate aspect of the present invention, the screw head is formed in a forging procedure.

In yet a further separate aspect of the present invention, the thread portion is formed in a thread-rolling procedure.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a magnesium screw manufacturing method in accordance with a first preferred embodiment of the present invention.

FIG. 2 is a flow chart of a magnesium screw manufacturing method in accordance with a second preferred embodiment of the present invention.

FIG. 3 is a flow chart of a magnesium screw manufacturing method in accordance with a third preferred embodiment of the present invention.

FIG. 4 is a side view of a magnesium screw blank in accordance with a preferred embodiment of the present invention.

FIG. 5 is a side view of a magnesium screw member in accordance with a preferred embodiment of the present invention, shown in FIG. 4.

### DETAILED DESCRIPTION OF THE INVENTION

It is noted that a magnesium screw manufacturing method in accordance with the preferred embodiment of the present invention is suitable for producing various screws, for example, including machine screws, self-tapping screws, hexagon and hexagon socket screws, shoulder screws, Sems screws or other special screws which are not limitative of the present invention. The magnesium screw manufacturing method and magnesium screw member produced thereby is applicable to various international standards, including ISO (International Organization for Standardization), ANSI (American National Standards Institute), JIS (Japanese Industrial Standards), DIN (German National Standards) and BSW (British Standard Whitworth) etc.

A magnesium screw member produced by the magnesium screw manufacturing method in accordance with the preferred embodiment of the present invention is made from magnesium or magnesium alloys which have a perfect degree of physical and chemical characteristics of magnesium metal. It will be understood that the magnesium screw member may not be made from other ordinary metals, including stainless steel, low-carbon steel (mild steel), medium carbon steel, alloy steel and bronze, for example.

FIG. 1 shows a flow chart of a magnesium screw manufacturing method in accordance with a first preferred embodiment of the present invention. With continued reference to FIG. 1, the magnesium screw manufacturing method includes the step S1A of: providing a magnesium wire or rod with a predetermined diameter. The predetermined diameter of the magnesium wire or rod is preformed and suitable for forming a magnesium screw member.

Still referring to FIG. 1, the magnesium screw manufacturing method includes the step S2A of: directly heating the magnesium wire or rod to a predetermined temperature in a heater. The predetermined temperature ranges between 100° C. and 300° C. which is not limitative of the present invention.

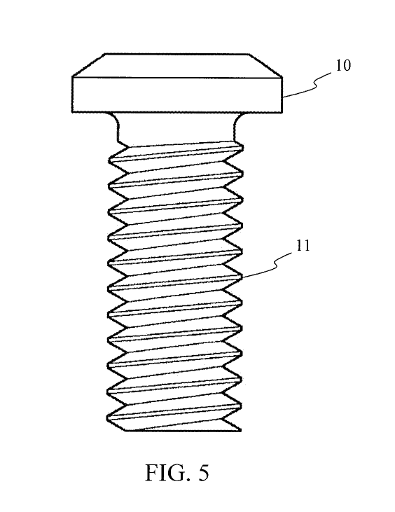

FIG. 4 shows a top view of a magnesium screw blank in accordance with a preferred embodiment of the present invention; FIG. 5 shows a top view of a magnesium screw member in accordance with a preferred embodiment of the present invention, as best shown in FIG. 5.

Referring again to FIGS. 1 and 4, the magnesium screw manufacturing method includes the step S3A of: forming a screw head 10 of a magnesium screw blank 1 from the magnesium wire or rod by a screw heading machine in the predetermined temperature. In screw heading operation, the screw head 10 of the magnesium screw blank 1 is forged. In the preferred embodiment, one-step or multi-step forging is applied to the magnesium wire or rod to form the magnesium screw blank 1.

By way of example, the types of the screw head 10 include cheese heads, binding heads, pan heads, truss heads, flat heads, oval heads, hexagon heads, hexagon washer heads, and pan washer heads which are not limitative of the present invention. The screw head 10 may be a slotted head formed with various types, including a slotted type, a Phillips recess type, a square socket type, a hexagon type, an indented hexagon type, a slotted and square socket type, a slotted and Phillips combination type, a plane hexagon type, an H type, a TX type, a TX tamper resistant type and a PZ drive type which are not limitative of the present invention.

With continued reference to FIGS. 1 and 4, in step S3A, a thread portion 11 is further formed on an outer circumferential surface of a screw rod by a thread-rolling machine or the like to produce a magnesium screw product such that the magnesium screw member will be completely manufactured.

By way of example, the thread portion 11 may be a single thread, a double thread, a high-low thread or a tri-lobular thread which is not limitative of the present invention. Referring again to FIG. 5, the magnesium screw product is processed in a surface treatment to produce the magnesium screw member.

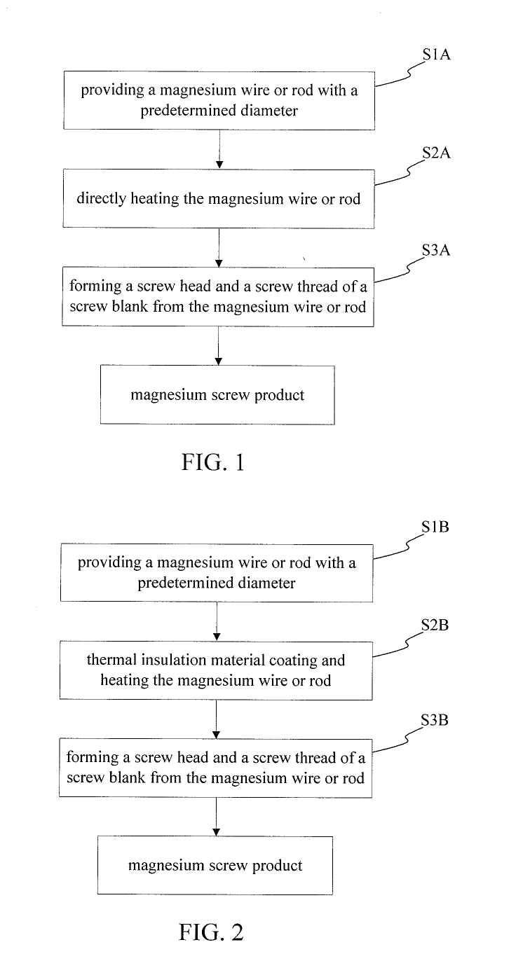

Turning now to FIG. 2, a flow chart of a magnesium screw manufacturing method in accordance with a second preferred embodiment of the present invention is shown. Steps S1B and S3B of the second embodiment are identical with steps S1A and S3A of the first embodiment and the detail description of steps S1B and S3B are omitted.

Referring to FIG. 2, the magnesium screw manufacturing method of the second preferred embodiment includes the step S3B of: coating a thermal insulation material on at least one predetermined section (i.e. outer circumferential surface) of the magnesium wire or rod in a thermal isolating procedure, and subsequently heating the magnesium wire or rod to the predetermined temperature in a heater. It will be understood that a thermal isolating and directly heating treatment is applied to the magnesium wire or rod. In step S2B, prior to heating operation, the predetermined section of the magnesium wire or rod is coated by a thermal insulation material so as to avoid thermal energy loss from the magnesium wire or rod to the ambient environment. By way of example, the coating technology may be roller coating or spray coating which is not limitative of the present invention.

In step S3B, after heating operation, the predetermined section of the heated magnesium wire or rod coated by the thermal insulation material is processed to form the magnesium screw member in the predetermined temperature without the need of further heating operation.

In the second preferred embodiment, the thermal insulation material may be selected from an inorganic material or an organic material. The inorganic material of the thermal insulation material may be selected from graphite or boron nitride (BN).

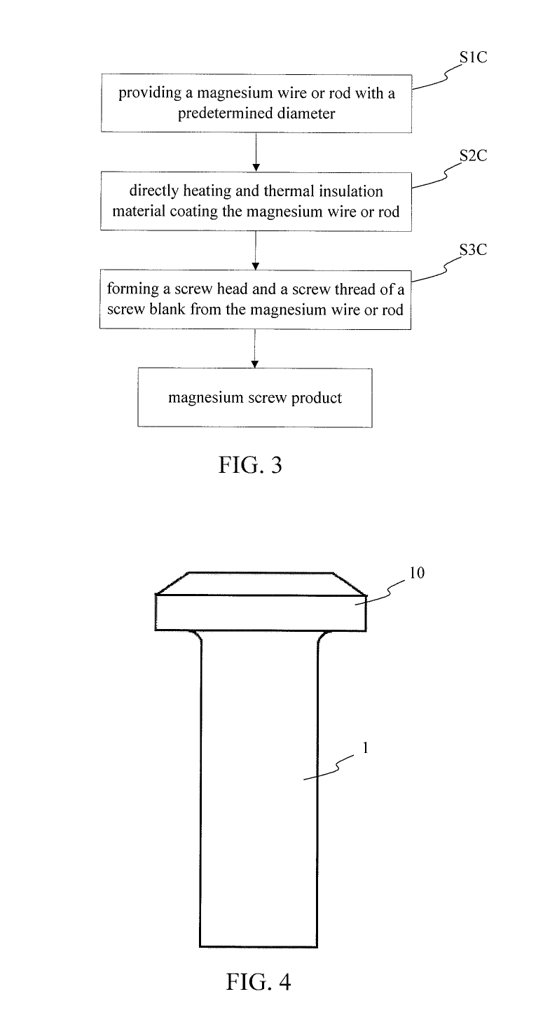

Turning now to FIG. 3, a flow chart of a magnesium screw manufacturing method in accordance with a third preferred embodiment of the present invention is shown. Steps S1C and S3C of the third embodiment are identical with steps S1A and S3A of the first embodiment and the detail description of steps S1C and S3C are omitted.

Still referring to FIG. 3, the magnesium screw manufacturing method of the third preferred embodiment includes the step S2B of: heating the magnesium wire or rod to the predetermined temperature, and subsequently coating the thermal insulation material on the predetermined section (i.e. outer circumferential surface) of the magnesium wire or rod in a thermal isolating procedure. In step S3C, after heating operation, the predetermined section of the heated magnesium wire or rod coated by the thermal insulation material is processed to form the magnesium screw member in the predetermined temperature.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. A magnesium screw manufacturing method, comprising the steps of:
providing a magnesium wire or rod with a predetermined diameter;
directly heating the magnesium wire or rod in a predetermined temperature; and
a screw head and a screw thread of a screw blank from the magnesium wire or rod.

2. The magnesium screw manufacturing method as defined in claim 1, wherein the predetermined temperature ranges between ranges between 100° C. and 300° C.

3. The magnesium screw manufacturing method as defined in claim 1, wherein the magnesium wire or rod is forged to form the screw head, and the screw thread is formed in a thread-rolling procedure.

4. The magnesium screw manufacturing method as defined in claim 1, wherein the magnesium wire or rod is coated by a thermal insulation material prior to heating the magnesium wire or rod, or after heating the magnesium wire or rod.

5. The magnesium screw manufacturing method as defined in claim 4, wherein the thermal insulation material is coated on a predetermined section of the magnesium wire or rod.

6. The magnesium screw manufacturing method as defined in claim 4, wherein the thermal insulation material is selected from an inorganic material or an organic material.

7. A magnesium screw member comprising:
a screw head formed from a magnesium wire or rod directly heated in a predetermined temperature;
a screw rod connected with the screw head; and
a screw thread formed on an outer circumferential surface of the screw rod.

8. The magnesium screw member as defined in claim 7, wherein the predetermined temperature ranges between ranges between 100° C. and 300° C.

9. The magnesium screw member as defined in claim 7, wherein the magnesium wire or rod is coated by a thermal insulation material prior to heating the magnesium wire or rod or after heating the magnesium wire or rod.

10. The magnesium screw member as defined in claim 9, wherein the thermal insulation material is coated on a predetermined section of the magnesium wire or rod.

11. The magnesium screw member as defined in claim 9, wherein the thermal insulation material is selected from an inorganic material or an organic material.
